(19) United States
(12) Patent Application Publication
(10) Pub. No.: US 2026/0230018 A1
(43) Pub. Date: Aug. 6, 2026

(54) Motor Control Device and Electric Vehicle

(71) Applicant: Astemo, Ltd., Chiyoda-ku, Tokyo (JP)

(72) Inventors: Shun TANIGUCHI, Tokyo (JP); Kentaro MATSUO, Hitachinaka-shi, Ibaraki (JP); Toshiyuki AJIMA, Tokyo (JP)

(21) Appl. No.: 19/150,573

(22) PCT Filed: Mar. 7, 2024
(86) PCT No.: PCT/JP2024/008884

§ 371 Date: Jul. 24, 2025

(30) Foreign Application Priority Data
Mar. 15, 2023 (JP) 2023-041029

(51) Int. Cl. H02P 21/22; H02P 27/06

(52) U.S. Cl. CPC H02P 21/22; H02P 27/06

(57) ABSTRACT

A motor control device includes: a current command value generation unit which generates a current command value based on a motor torque command value and a rotation speed of a motor; a torque command value calculation unit which calculates a torque command value based on the generated current command value and calculates a torque of the motor based on a detection value of a current flowing through the motor; a voltage phase control unit which controls a voltage phase angle such that the torque of the motor matches with the torque command value; and a power conversion unit which converts DC power into AC power based on the voltage phase angle and rotation angle information of the motor, and outputs the converted AC power to the motor. The current command value generation unit calculates a d-axis current command value or a q-axis current command value such that a current command value of any one axis of the d-axis current command value and the q-axis current command value constituting the current command value approaches a current detection value of the axis.

### TECHNICAL FIELD

The present invention relates to a motor control device and an electric vehicle.

### BACKGROUND ART

DC power is converted into AC power by a power conversion unit, and a rectangular wave voltage is applied to a motor by voltage phase control to rotationally drive the motor. According to this voltage phase control, output of a high rotation speed region of the motor can be improved, the number of switching operations in the power conversion unit can be reduced, and a switching loss can be suppressed. Then, in order to improve a voltage utilization rate of the motor, pulse saving control in which the number of pulses in one cycle of the rectangular wave voltage is reduced is used. In this voltage phase control, it is necessary to control a voltage phase such that a torque of the motor matches with a motor torque command value. Then, the motor torque command value is converted into a current command value, and control is performed by comparison with a current detection value of the motor.

PTL 1 discloses a device which generates a torque deviation representing a difference between a detected torque value and a given motor torque command value and sets a phase of the rectangular wave voltage so as to eliminate the torque deviation. PTL 2 discloses a device which switches between a rectangular wave control method by torque feedback control and a PWM control method by motor current feedback control according to an operating condition of the motor. PTL 3 discloses a device which corrects a current command value by calculating a current deviation between an actual current detected immediately before switching and the current command value at a time of switching from a voltage phase control mode to a current control mode. PTL 4 discloses a device which includes a voltage calculation unit which calculates a magnetic flux command value from a current command value, estimates a magnetic flux value from a current detection value, and generates a voltage command value such that the magnetic flux command value and the magnetic flux value match, and a damping ratio control unit which generates a correction amount of the voltage command value so as to damp a vibration component, based on the vibration component of the magnetic flux value.

### CITATION LIST

### Patent Literature

PTL 1: JP 2000-050689 A
PTL 2: JP 2006-311770 A
PTL 3: JP 2010-268568 A
PTL 4: JP 2022-144060 A

### SUMMARY OF INVENTION

### Technical Problem

In the devices of PTLs 1 to 4, the current command value diverges from the current detection value of the motor, and the operation of the control using the current command value becomes unstable.

### Solution to Problem

A motor control device according to the present invention includes: a current command value generation unit which generates a current command value based on a motor torque command value and a rotation speed of a motor; a torque command value calculation unit which calculates a torque command value based on the generated current command value and calculates a torque of the motor based on a detection value of a current flowing through the motor; a voltage phase control unit which controls a voltage phase angle such that the torque of the motor matches with the torque command value; and a power conversion unit which converts DC power into AC power based on the voltage phase angle and rotation angle information of the motor, and outputs the converted AC power to the motor. The current command value generation unit calculates a d-axis current command value or a q-axis current command value such that a current command value of any one axis of the d-axis current command value and the q-axis current command value constituting the current command value approaches a current detection value of the axis.

### Advantageous Effects of Invention

According to the present invention, the divergence between the current command value and the current detection value of the motor can be suppressed, and the operation of the control using the current command value can be stabilized.

### BRIEF DESCRIPTION OF DRAWINGS

FIG. 1 is an overall configuration diagram of a motor control device according to a first embodiment.

FIG. 2 is a block configuration diagram of a torque command value calculation unit according to the first embodiment.

FIG. 3 is a block configuration diagram of a voltage phase control unit in the first embodiment.

FIG. 4 is a block configuration diagram of a damping ratio control unit according to the first embodiment.

FIG. 5 is a block configuration diagram of a rectangular wave generation unit according to the first embodiment.

FIG. 6 is a block configuration diagram of a current command value generation unit according to the first embodiment.

FIG. 7 is an example of a case where a d-axis current command value generation unit according to the first embodiment is configured by a lookup table.

FIG. 8 is a block configuration diagram of a current command value generation unit according to a first modification of the first embodiment.

FIG. 9 is a block configuration diagram of a current command value generation unit according to a second modification of the first embodiment.

FIG. 10 is a block configuration diagram of a current command value generation unit in a third modification of the first embodiment.

FIG. 11 is an overall configuration diagram of a motor control device according to a second embodiment.

FIG. 12 is a block configuration diagram of a second torque command value calculation unit according to the second embodiment.

FIG. 13 is a block configuration diagram of a voltage phase control unit according to the second embodiment.

FIG. 14 is a block configuration diagram of a current command value generation unit according to the second embodiment.

FIG. 15 is a block configuration diagram of a current command value generation unit in a fourth modification of the second embodiment.

FIG. 16 is an overall configuration diagram of a motor control device according to a third embodiment.

FIG. 17 is a block configuration diagram of a current command value generation unit according to the third embodiment.

FIG. 18 is a configuration diagram of an electric vehicle in a fourth embodiment.

### DESCRIPTION OF EMBODIMENTS

Hereinafter, embodiments of the present invention will be described with reference to the drawings. The following description and drawings are examples for describing the present invention, and are omitted and simplified as appropriate for the sake of clarity of description. The present invention can be carried out in various other forms. Unless otherwise specified, each component may be singular or plural.

### First Embodiment

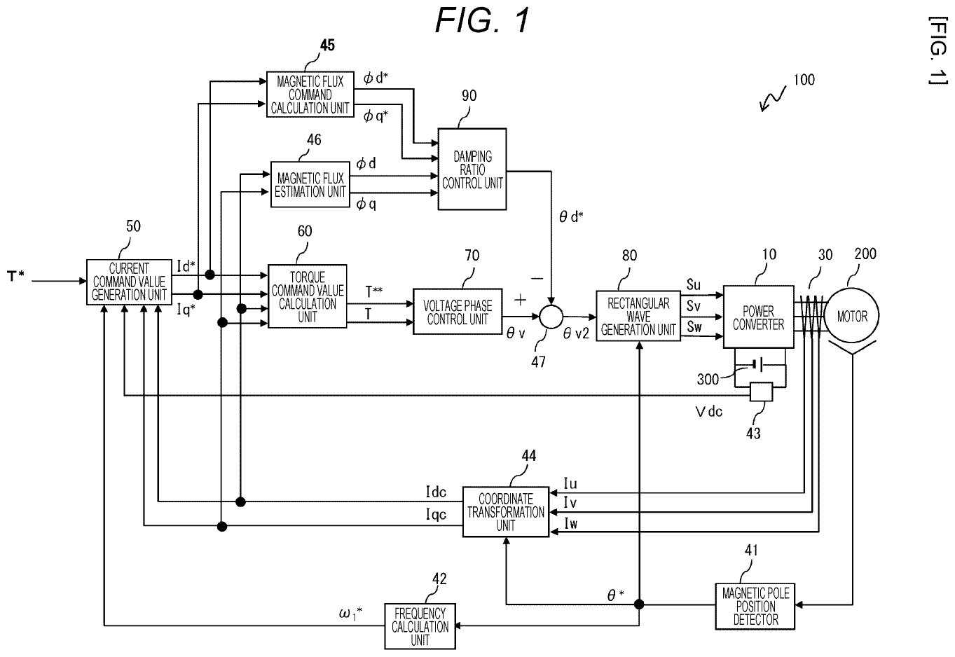

FIG. 1 is an overall configuration diagram of a motor control device 100 according to a first embodiment of the present invention. The motor control device 100 controls driving of a motor 200 by converting DC power into AC power by a power converter 10.

The motor 200 is intended for a permanent magnet synchronous motor (PMSM), but the effect of the present invention is not limited to the permanent magnet synchronous motor, and similar effects can be obtained with an AC machine such as a synchronous reluctance motor, a permanent magnet synchronous generator, a winding-type synchronous machine, an induction motor, or an induction generator. In addition, a semiconductor switching element of the power converter 10, which is an inverter, is intended for an IGBT, but is not limited thereto, and may be a MOSFET or other switching elements.

In FIG. 1, the power converter 10 converts DC power from a DC power supply 300 (for example, a battery) into AC power according to a gate signal G, to drive the motor 200. Three-phase current values Iu, Iv, and Iw of a U phase, a V phase, and a W phase flowing from the power converter 10 to the motor 200 are detected by a current detector 30. The current detector 30 includes a Hall current transformer (CT) or the like.

A magnetic pole position detector 41 is arranged near the motor 200. The magnetic pole position detector 41 includes a resolver or the like, detects a magnetic pole position of the motor 200, and outputs rotation angle information θ*.

A frequency calculation unit 42 outputs rotation speed ω1* from rotation angle information θ* detected by the magnetic pole position detector 41, for example, by differential calculation. A voltage detector 43 detects the voltage of the DC power supply 300 and outputs a DC voltage Vdc that is the voltage information.

A coordinate transformation unit 44 coordinate-transforms the three-phase current values Iu, Iv, and Iw detected by the current detector 30 with the rotation angle information θ* detected by the magnetic pole position detector 41, and outputs a d-axis current detection value Idc and a q-axis current detection value Iqc.

In the current command value generation unit 50, a motor torque command value T* is input from a host control device (not illustrated), the rotation speed ω1* of the motor 200 is input from the frequency calculation unit 42, the DC voltage Vdc is input from the voltage detector 43, and the d-axis current detection value Idc and the q-axis current detection value Iqc are input from the coordinate transformation unit 44. The current command value generation unit 50 generates a d-axis current command value Id* and a q-axis current command value Iq* based on the input information. Details of the current command value generation unit 50 will be described later.

A torque command value calculation unit 60 calculates a torque command value T** and a torque T based on the d-axis current command value Id* and the q-axis current command value Iq*, the d-axis current detection value Idc, and the q-axis current detection value Iqc, and outputs the calculated values to a voltage phase control unit 70. Details of the torque command value calculation unit 60 will be described later.

The voltage phase control unit 70 calculates a voltage phase angle θv such that the torque T matches with the torque command value T**, and outputs the voltage phase angle θv to a subtractor 47. Details of the voltage phase control unit 70 will be described later.

A magnetic flux command calculation unit 45 uses the d-axis current command value Id* and the q-axis current command value Iq* to output a d-axis magnetic flux command value φd* and a q-axis magnetic flux command value φq* with reference to, for example, a lookup table. A magnetic flux estimation unit 46 uses the d-axis current detection value Idc and the q-axis current detection value Iqc to estimate a d-axis magnetic flux estimation value φdc and a q-axis magnetic flux estimation value qc with reference to, for example, a lookup table. A damping ratio control unit 90 uses the d-axis magnetic flux command value φd*, the q-axis magnetic flux command value φq*, the d-axis magnetic flux estimation value φdc, and the q-axis magnetic flux estimation value φqc to calculate a phase angle correction amount θd* which corrects the voltage phase angle θv so as to damp the vibration component of the magnetic flux value. Details of the damping ratio control unit 90 will be described later.

The subtractor 47 subtracts the phase angle correction amount θd* from the voltage phase angle θv and outputs a voltage phase angle θv2 to a rectangular wave generation unit 80. That is, the voltage phase angle θv is corrected based on the phase angle correction amount θd*.

The rectangular wave generation unit 80 generates pulse signals Su, Sv, and Sw corresponding to the voltage phase angle θv2 based on the voltage phase angle θv2 and the rotation angle information θ*, and outputs the pulse signals Su, Sv, and Sw to a power conversion unit 2. Details of rectangular wave generation unit 80 will be described later.

In the power converter 10, an inverter is configured by the semiconductor switching element, and the semiconductor switching element is controlled by the pulse signals Su, Sv, and Sw to be turned on/off. As a result, the DC power supplied from the DC power supply 300 is converted into AC power to rotationally drive the motor 200. Note that the rectangular wave generation unit 80 and the power converter 10 are collectively referred to as a power conversion unit.

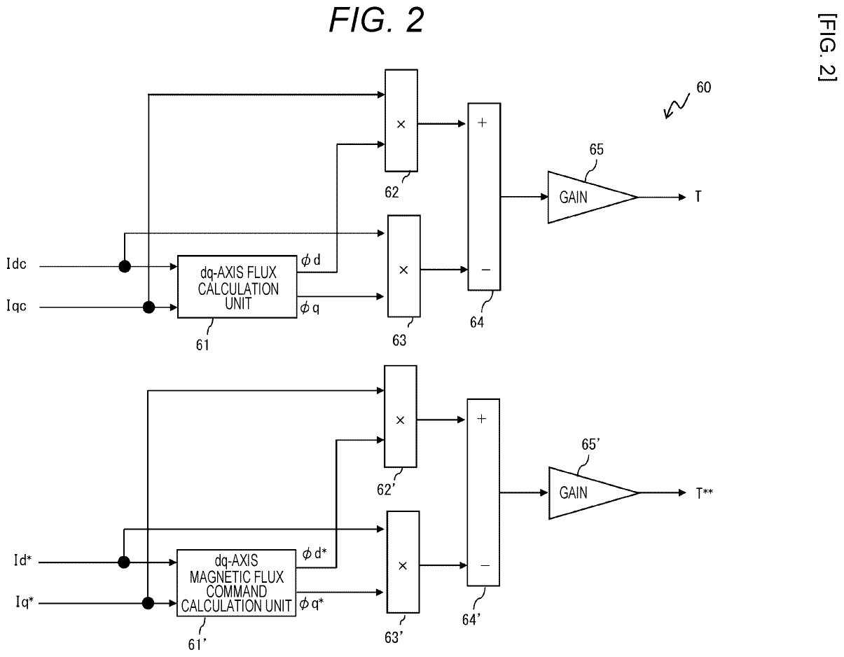

FIG. 2 is a block configuration diagram of the torque command value calculation unit 60.

The torque command value calculation unit 60 includes dq-axis magnetic flux calculation units 61 and 61′, multipliers 62 and 62′, 63 and 63′, subtractors 64 and 64′, and amplifiers 65 and 65′ in order to calculate the torque T.

The dq-axis magnetic flux calculation unit 61 calculates, based on the d-axis current detection value Idc and the q-axis current detection value Iqc, a d-axis magnetic flux od and a q-axis magnetic flux φq in, for example, a lookup table. Then, the torque T expressed by following Expression (1) is calculated using the multipliers 62 and 63, the subtractor 64, and the amplifier 65.

$$\begin{matrix}[ Mathematical Formula 1 ] & \\ T = \frac{3}{2} P ( {ϕ}_{t} {I}_{q c} - {ϕ}_{q} {I}_{d c} ) & ( Expression 1 )\end{matrix}$$

Here, P is the number of pole pairs of the motor 200.

A dq-axis magnetic flux calculation unit 61′ calculates, based on the d-axis current command value Id* and the q-axis current command value Iq*, the d-axis magnetic flux command value φd* and the q-axis magnetic flux command value φq* in, for example, a lookup table. Then, the torque command value T** expressed in following Expression (2) is calculated using the multipliers 62′ and 63′, the subtractor 64′, and the amplifier 65′.

$$\begin{matrix}[ Mathematical Formula 2 ] & \\ {T}^{* *} = \frac{3}{2} P ( {ϕ}_{d}^{⋆} {I}_{q}^{*} - {ϕ}_{q}^{*} {I}_{d}^{*} ) & ( Expression 2 )\end{matrix}$$

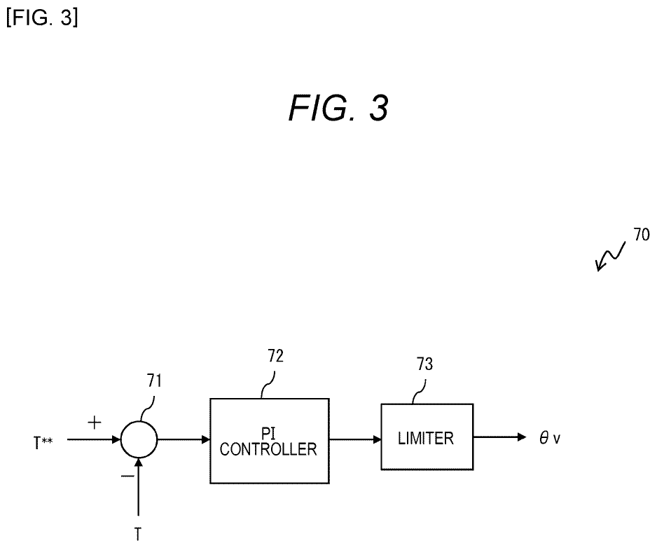

FIG. 3 is a block configuration diagram of the voltage phase control unit 70.

The voltage phase control unit 70 includes a differentiator 71, a PI controller 72, and a limiter 73. As illustrated in FIG. 3, a difference between the torque T and the torque command value T** is calculated by the differentiator 71, passes through the PI controller 72 (or an I controller), performs limiting processing by the limiter 73, and outputs the voltage phase angle θv.

A cutoff frequency of the voltage phase control unit 70 is 3 times or more higher than a cutoff frequency of the current command value generation unit 50 described later. For example, the PI controller 72 sets a gain Kp of P control and a gain KI of the I control as shown in following Expressions (3) and (4).

$$Kp = 0 \qquad ( 3 )$$

$$KI = ωc / ( 3 / 2 \times P \times ( Id \times ( Ld \times Id + φ m ) - ( Ld \times Id + φ m ) \hat{} 2 / Lq + ( 1 / Lq - 1 / Ld ) \times Lq \hat{} 2 \times Iq \hat{} 2 ) \qquad ( 4 )$$

Here, ωc is the cutoff frequency of the voltage phase control unit 70, φm is a magnet magnetic flux, Ld is a d-axis inductance, and Lq is a q-axis inductance.

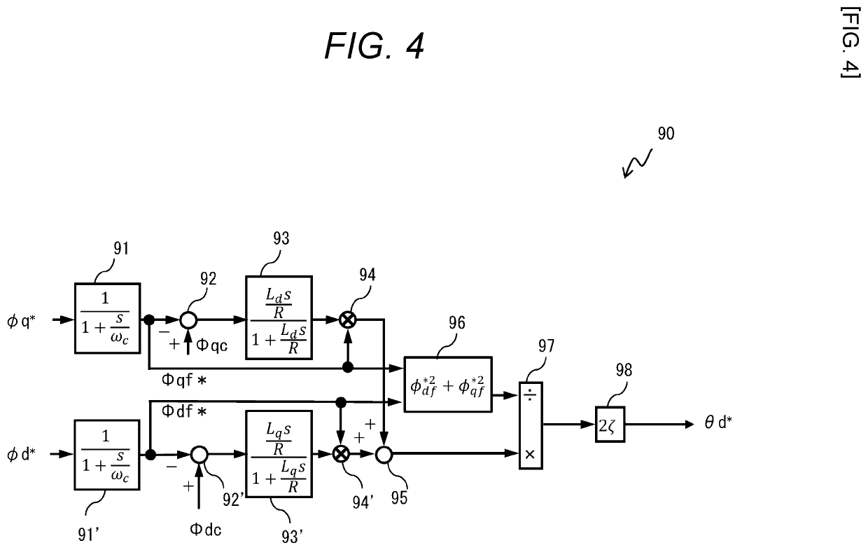

FIG. 4 is a block configuration diagram of the damping ratio control unit 90.

As illustrated in FIG. 4, a first-order lag calculator 91 calculates a first-order lag φqf* of the q-axis magnetic flux command value φq*. In addition, a first-order lag calculator 91′ calculates the first-order lag φdf* of the d-axis magnetic flux command value φd*. Note that a reciprocal of the cutoff frequency ωc of the voltage phase control unit 70 is a time constant at the first-order lag. Furthermore, a difference (φqc−φqf*) between the q-axis magnetic flux estimation value qqc and the first-order lag φqf* of the q-axis magnetic flux command value φq* is calculated by an adder-subtractor 92. A vibration component of the difference is extracted by a high-pass filter 93 (a transfer function is illustrated in FIG. 4).

In addition, a difference (φdc−φdf*) between the d-axis magnetic flux estimation value φdc and the first-order lag φdf* of the d-axis magnetic flux command value φd* is calculated by an adder-subtractor 92′. A vibration component of the difference is extracted by a high-pass filter 93′ (a transfer function is illustrated in FIG. 4).

That is, the vibration components of the q-axis magnetic flux and the d-axis magnetic flux are extracted by the high-pass filters 93 and 93′, respectively. Furthermore, the first-order lag φqf* of the q-axis magnetic flux command value φq* is multiplied by the vibration component of the q-axis magnetic flux extracted by the high-pass filter 93 by a multiplier 94. In addition, the first-order lag φdf* of the d-axis magnetic flux command value φd* is multiplied by the vibration component of the d-axis magnetic flux extracted by the high-pass filter 93′ by a multiplier 94′.

A multiplication value by the multiplier 94 and a multiplication value by the multiplier 94′ are added by an adder 95. An addition value by the adder 95 corresponds to an inner product of the magnetic flux command vector and the vibration component vector of the magnetic flux. Note that the first-order lag φqf* of the q-axis magnetic flux command value φq* and the first-order lag φdf* of the d-axis magnetic flux command value φd* are also input to a square sum calculator 96 in addition to the multipliers 94 and 94′. The square sum calculator 96 calculates a sum of the square of φqf* and the square of φdf*.

A square sum calculation value ((φqf*)2+(φdf*)2) by the square sum calculator 96 and the addition value by the adder 95 are input to a divider 97. The divider 97 divides the square sum calculation value by the square sum calculator 96 by the addition value by the adder 95 ((addition value)/(square sum)).

Here, a division value by the divider 97 is a value obtained by converting ((component of magnetic flux command in amplitude direction)/(magnitude of magnetic flux command (=((φqf*)2+(φdf*)2))½)) the value of the component of the magnetic flux command in the amplitude direction in the vibration component of the magnetic flux ((inner product of magnetic flux command vector and vibration component vector of magnetic flux)/(magnitude of magnetic flux command vector (=((φqf*)2+(φdf*)2))½)) into the phase correction amount of the voltage command (provisional correction amount before gain multiplication). The division value by the divider 97 is multiplied by a gain (2ζ) by a proportional element 98. As described above, the phase angle correction amount θd* is calculated.

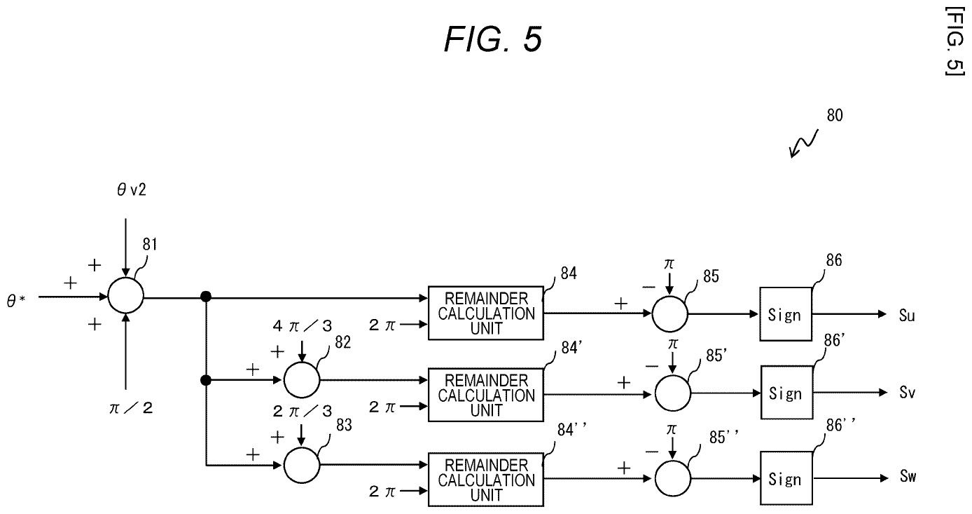

FIG. 5 is a block configuration diagram of the rectangular wave generation unit 80.

The rectangular wave generation unit 80 includes adders 81, 82, and 83, remainder calculation units 84, 84′, and 84″, differentiators 85, 85′, and 85″, and sign determination units 86, 86′, and 86″.

As illustrated in FIG. 5, the adder 81 adds the voltage phase angles θv2 and π/2 to the rotation angle information θ* to generate a voltage phase signal. The remainder calculation unit 84 calculates a remainder obtained by dividing the generated voltage phase signal by 2π. Then, the differentiator 85 subtracts π, the sign determination unit 86 determines the sign, and outputs a pulse signal Su according to a determination result. For example, if the determination result by the sign determination unit 86 is positive, +1 is output, and if the determination result is negative, −1 is output.

The adder 82 adds 4π/3 to the voltage phase signal generated by the adder 81. The remainder calculation unit 84′ calculates a remainder obtained by dividing the added voltage phase signal by 2π. Then, the differentiator 85′ subtracts II, the sign determination unit 86′ determines the sign, and outputs a pulse signal Sv according to a determination result.

The adder 83 adds 2π/3 to the voltage phase signal generated by the adder 81. The remainder calculation unit 84″ calculates a remainder obtained by dividing the added voltage phase signal by 21. Then, the differentiator 85″ subtracts II, the sign determination unit 86″ determines the sign, and outputs a pulse signal Sw according to a determination result.

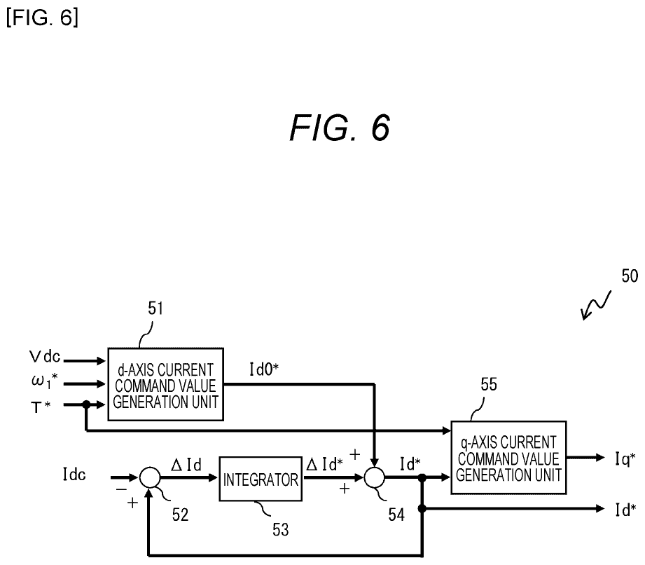

FIG. 6 is a block configuration diagram of the current command value generation unit 50.

The current command value generation unit 50 includes a d-axis current command value generation unit 51, a subtractor 52, an integrator 53, an adder 54, and a q-axis current command value generation unit 55.

The d-axis current command value generation unit 51 generates, from the motor torque command value T*, the DC voltage Vdc, and the rotation speed ω1*, an initial d-axis current command value Id0* in a lookup table, for example.

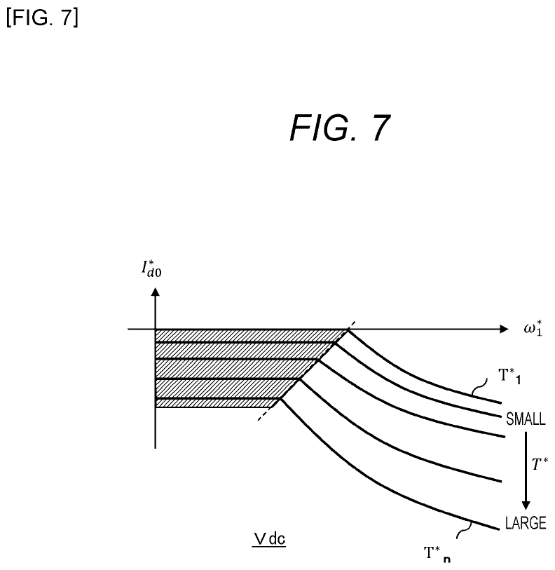

FIG. 7 illustrates an example in which the d-axis current command value generation unit 51 is configured by a lookup table.

In the lookup table, as illustrated in FIG. 7, a horizontal axis represents the rotation speed ω1* and a vertical axis represents the initial d-axis current command value Id0* at a certain DC voltage Vdc. The motor torque command value T* is drawn as a graph defined for each size.

Focusing on a specific motor torque command value T*, the initial d-axis current command value Id0* is a constant value until the rotation speed ω1* exceeds a specific value, but when the rotation speed ω1* exceeds the specific value, the initial d-axis current command value Id0* increases in a negative direction according to the rotation speed ω1*. In addition, when the motor torque command value T* increases, the graph of the motor torque command value T* is shifted in a negative direction such that the initial d-axis current command value Id0* increases in the negative direction.

Although FIG. 7 illustrates a lookup table at a certain DC voltage Vdc, a large number of lookup tables are stored in advance according to the DC voltage Vdc. Then, in this lookup table, a correspondence relationship between the motor torque command value T*, the DC voltage Vdc, the rotation speed ω1*, and the initial d-axis current command value Id0* is obtained by a test of the motor 200 or the like. Note that, in a specific motor torque command value T*, a hatched region in FIG. 7 where the initial d-axis current command value Id0* is a constant value until the rotation speed ω1* exceeds the specific value is a d-axis current command value that becomes maximum torque per ampere (MTPA, (maximum torque/current)).

The description returns to FIG. 6. The subtractor 52 calculates a current difference ΔId between a previous value of the d-axis current command value Id* and the d-axis current detection value Idc. The integrator 53 outputs a d-axis current command value correction amount ΔId* based on the current difference ΔId by following Expression (5).

$$Δ {Id}^{⋆} = \int ω fb \times Δ Id \qquad ( 5 )$$

Here, ωfb is a cutoff frequency. When the current difference ΔId is multiplied by the cutoff frequency ωfb as a gain, a current error converges at the cutoff frequency ωfb. At this time, a sufficiently slow response of the voltage phase control unit 70 does not interfere with the response of the torque control. For example, the cutoff frequency of the voltage phase control unit 70 is set to a value which is 3 times or more higher than the cutoff frequency of the current command value generation unit 50.

The adder 54 adds the d-axis current command value correction amount ΔId* to the initial d-axis current command value Id0* and outputs the d-axis current command value Id*.

That is, the subtractor 52, the integrator 53, and the adder 54 calculate the d-axis current command value Id* such that the d-axis current command value Id* approaches the d-axis current detection value Idc.

The q-axis current command value generation unit 55 generates, based on the calculated d-axis current command value Id* and the motor torque command value T*, the q-axis current command value Iq* using a lookup table or Expression (6). At this time, the q-axis current command value generation unit 55 changes the q-axis current command value Iq* such that the torque does not change. In other words, the q-axis current command value Iq* is the q-axis current command value Iq* along an equal torque line in the relationship with the calculated d-axis current command value Id*.

$$\begin{matrix}[ Mathematical Formula 3 ] & \\ {I}_{q}^{*} = \frac{{T}^{*}}{\frac{3}{2} P ( {ϕ}_{m} + ( {L}_{d} - {L}_{q} ) {I}_{d}^{*} )} & ( Expression 6 )\end{matrix}$$

Here, φm is the magnet magnetic flux, Ld is the d-axis inductance, Lq is the q-axis inductance, and P is the number of pole pairs of the motor 200. In a case where temperature correction is performed on the magnet magnetic flux om or a case where magnetic saturation is considered for a d-axis inductance Ld and a q-axis inductance Lq, the q-axis current command value Iq* may be determined using these as parameters.

With the above configuration, the d-axis current command value Id* matches with the d-axis current detection value Idc. In addition, in FIG. 2, in a case where the torque T and the torque command value T** match and the d-axis current command value Id* and the d-axis current detection value Idc match, the configuration of block is the same, and thus, if an output and one of two inputs match, the output also matches with the remaining input, so that the q-axis current command value Iq* matches with the q-axis current detection value Iqc. As a result, the current command value matches with the current detection value in the voltage phase control.

Note that although it has been described that the current command value matches with the current detection value, the present invention is not limited to the complete match, and includes a case where the current command value approaches the current detection value. The same applies not only to the present embodiment but also to other embodiments and modifications.

As described above, the current command value generation unit 50 calculates the d-axis current command value Id* such that the d-axis current command value Id* approaches the d-axis current detection value Idc, and calculates the q-axis current command value Iq* along the equal torque line based on the calculated d-axis current command value Id*. As a result, the divergence between the current command value and the current detection value of the motor 200 can be suppressed, and the operation of the control using the current command value can be stabilized.

Furthermore, the present embodiment includes the damping ratio control unit 90 that realizes stabilization by converting the d-axis current command value Id* into the d-axis magnetic flux command value φd* and converting the q-axis current command value Iq* into the q-axis magnetic flux command value φq*. In this configuration, since the divergence between the current command value and the current detection value of the motor 200 is suppressed, a precondition that the d-axis magnetic flux command value φd* and the q-axis magnetic flux command value φq* match with the d-axis magnetic flux φd and the q-axis magnetic flux φq in a steady state is satisfied, and the effect of stabilization can be further obtained.

Note that, in the present embodiment, an example of outputting a rectangular wave pulse has been described. However, for example, a similar effect can be obtained also in a case where the voltage approaches an output limit as in three-pulse control, and the torque is controlled by the voltage phase control.

### First Modification

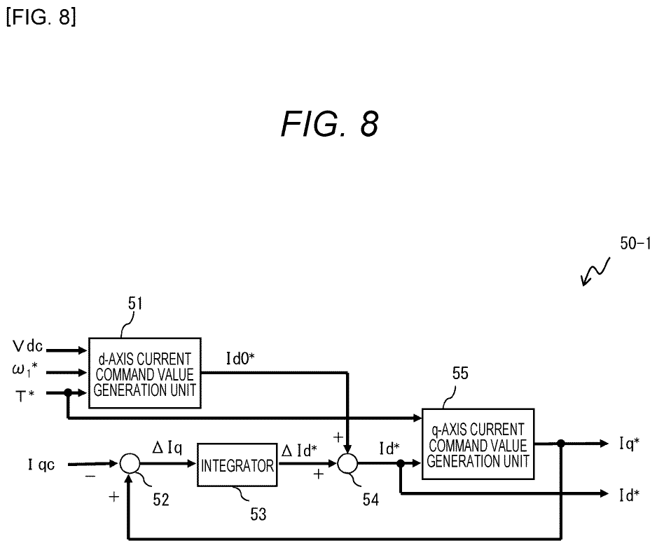

FIG. 8 is a block configuration diagram of a current command value generation unit 50-1 according to a first modification of the first embodiment. The d-axis current command value Id* is obtained such that the current command value matches with the q-axis current detection value instead of the d-axis current detection value, which is different from the configuration of the current command value generation unit 50 illustrated in FIG. 6. The same portions as those of the current command value generation unit 50 in FIG. 6 are denoted by the same reference numerals, and the description thereof will be simplified.

The subtractor 52 calculates a current difference ΔIq between a previous value of the q-axis current command value Iq* and the q-axis current detection value Iqc. The integrator 53 outputs the d-axis current command value correction amount ΔId* based on the current difference ΔIq by following Expression (7).

$$Δ {Id}^{⋆} = \int K fb \times Δ Iq \qquad ( 7 )$$

Here, Kfb is set as shown in following Expression (8). This is because simply multiplying the cutoff frequency ωfb in the integrator 53 and integrating it changes the response.

$$\begin{matrix}[ Mathematical Formula 4 ] & \\ {K}_{f ' b} = \frac{{ω}_{f b} ( {ϕ}_{m} + ( {L}_{d} - {L}_{q} ) {I}_{d}^{*} )}{( {L}_{d} - {L}_{q} ) {I}_{q}^{*}} & ( Expression 8 )\end{matrix}$$

Note that in Expression (8), the previous values are used for the d-axis current command value Id* and the q-axis current command value Iq*.

As in the first modification, even when the d-axis current command value Id* is obtained such that the d-axis current command value Id* matches with the q-axis current detection value, in FIG. 2, when the torque T and the torque command value T** match and the q-axis current detection value Iqc and the q-axis current command value Iq* match, the logic is not consistent if the remaining inputs do not match, and thus, the d-axis current command value Id* matches the d-axis current detection value Idc.

Also in the first modification, effects similar to those described in the first embodiment are obtained.

### Second Modification

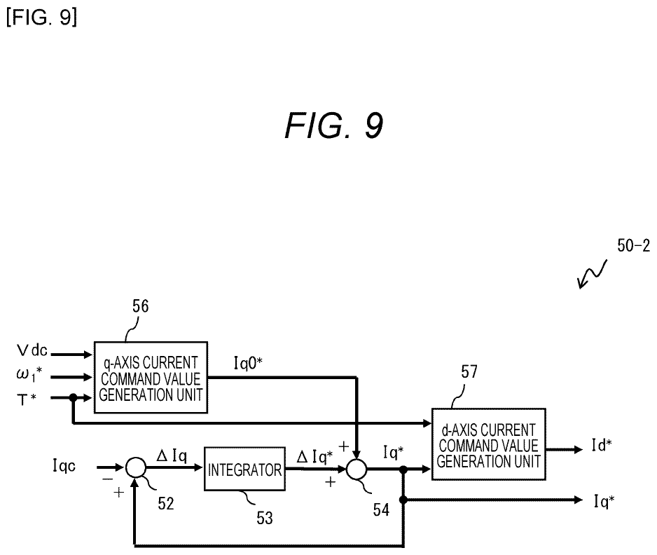

FIG. 9 is a block configuration diagram of a current command value generation unit 50-2 according to a second modification of the first embodiment. The current command value generation unit 50-2 is different from the current command value generation unit 50-1 illustrated in FIG. 8 in that the q-axis current detection value is obtained first instead of the d-axis current detection value. The same portions as those of the current command value generation unit 50 in FIG. 6 and the current command value generation unit 50-1 in FIG. 8 are denoted by the same reference numerals, and the description thereof will be simplified.

The q-axis current command value generation unit 56 generates, from the motor torque command value T*, the DC voltage Vdc, and the rotation speed ω1*, an initial q-axis current command value Iq0* in a lookup table, for example.

The subtractor 52 calculates a current difference ΔIq between a previous value of the q-axis current command value Iq* and the q-axis current detection value Iqc. The integrator 53 outputs a q-axis current command value correction amount ΔIq* by following Expression (9) based on the current difference ΔIq.

$$Δ {Iq}^{⋆} = \int ω fb \times Δ Iq \qquad ( 9 )$$

The d-axis current command value generation unit 57 calculates the d-axis current command value Id* using a lookup table or following Expression (10).

$$\begin{matrix}[ Mathematical Formula 5 ] & \\ {I}_{d}^{*} = \frac{{T}^{*} - \frac{3}{2} P {ϕ}_{m} {I}_{q}^{*}}{\frac{3}{2} P ( {L}_{d} - {L}_{q} ) {I}_{q}^{*}} & ( Expression 10 )\end{matrix}$$

Also in the second modification, effects similar to those described in the first embodiment are obtained.

### Third Modification

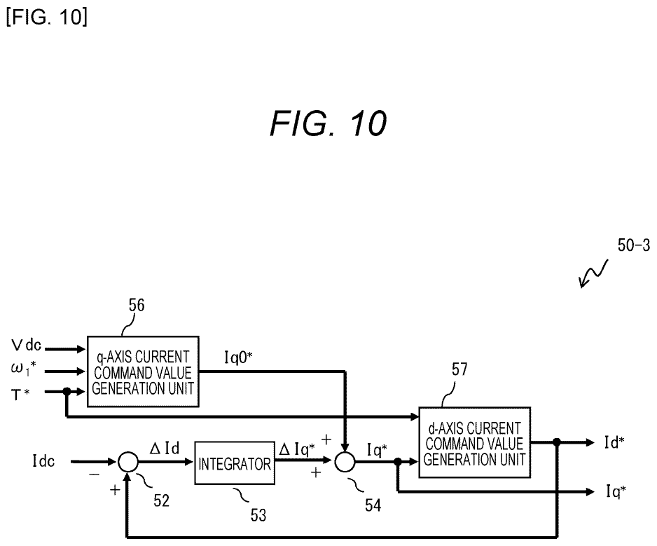

FIG. 10 is a block configuration diagram of a current command value generation unit 50-3 according to a third modification of the first embodiment. The q-axis current command value Iq* is obtained such that the q-axis current command value matches with the d-axis current detection value instead of the q-axis current detection value, which is different from the configuration of the current command value generation unit 50-2 illustrated in FIG. 9. The same portions as those of the current command value generation unit 50 in FIG. 6 and the current command value generation unit 50-2 in FIG. 9 are denoted by the same reference numerals, and the description thereof will be simplified.

The subtractor 52 calculates a current difference ΔId between a previous value of the d-axis current command value Id* and the d-axis current detection value Idc. The integrator 53 outputs the q-axis current command value correction amount ΔIq* by following Expression (11) based on the current difference ΔId.

$$Δ {Iq}^{⋆} = \int Kfb 2 \times Δ Id \qquad ( 11 )$$

Here, Kfb2 is set as shown by following Expression (12). This is because simply multiplying the cutoff frequency ωfb in the integrator 53 and integrating it changes the response.

$$\begin{matrix}[ Mathematical Formula 6 ] & \\ {K}_{f b 2} = \frac{{W}_{f b} ( {L}_{d} - {L}_{q} ) {I}_{q}^{*}}{( {ϕ}_{m} + ( {L}_{m} - {L}_{q} ) {I}_{d}^{*} )} & ( Expression 12 )\end{matrix}$$

Note that in Expression (12), the previous values are used for the d-axis current command value Id* and the q-axis current command value Iq*.

Also in the third modification, effects similar to those described in the first embodiment are obtained.

### Second Embodiment

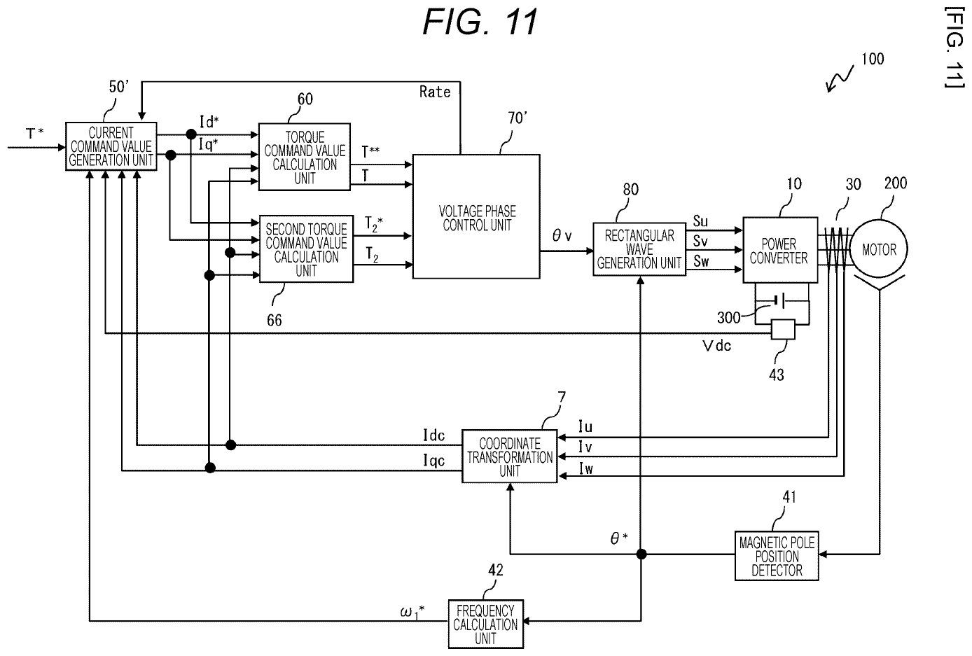

FIG. 11 is an overall configuration diagram of the motor control device 100 according to a second embodiment of the present invention.

The second embodiment includes a second torque command value calculation unit 66 as compared with the first embodiment. In addition, the second embodiment will be described as an example in which the magnetic flux command calculation unit 45, the magnetic flux estimation unit 46, and the damping ratio control unit 90 described in the first embodiment are not provided, but these configurations may be provided. The same portions as those of the motor control device 100 of the first embodiment illustrated in FIG. 1 are denoted by the same reference numerals, and the description thereof will be simplified.

The motor torque command value T*, the rotation speed ω1* of the motor 200, the DC voltage Vdc, the d-axis current detection value Idc, the q-axis current detection value Iqc, and Rate information to be described later are input to the current command value generation unit 50′. The current command value generation unit 50′ generates the d-axis current command value Id* and the q-axis current command value Iq* based on the input information, and outputs the d-axis current command value Id* and the q-axis current command value Iq* to the torque command value calculation unit 60 and the second torque command value calculation unit 66. Details of the current command value generation unit 50′ will be described later.

The second torque command value calculation unit 66 calculates a second torque command value T*2 and a second torque T2 based on the d-axis current command value Id*, the q-axis current command value Iq*, the d-axis current detection value Idc, and the q-axis current detection value Iqc, and outputs the second torque command value T*2 and the second torque T2 to the voltage phase control unit 70′. Details of the second torque command value calculation unit 66 will be described later.

The voltage phase control unit 70′ uses the torque command value T** in a low torque region of the motor 200, and uses a second torque command value T2* in a high torque region of the motor 200 to control the voltage phase angle θv such that the torque command value matches with the torque T of the motor 200 and outputs the voltage phase angle θv. Details of the voltage phase control unit 70′ will be described later.

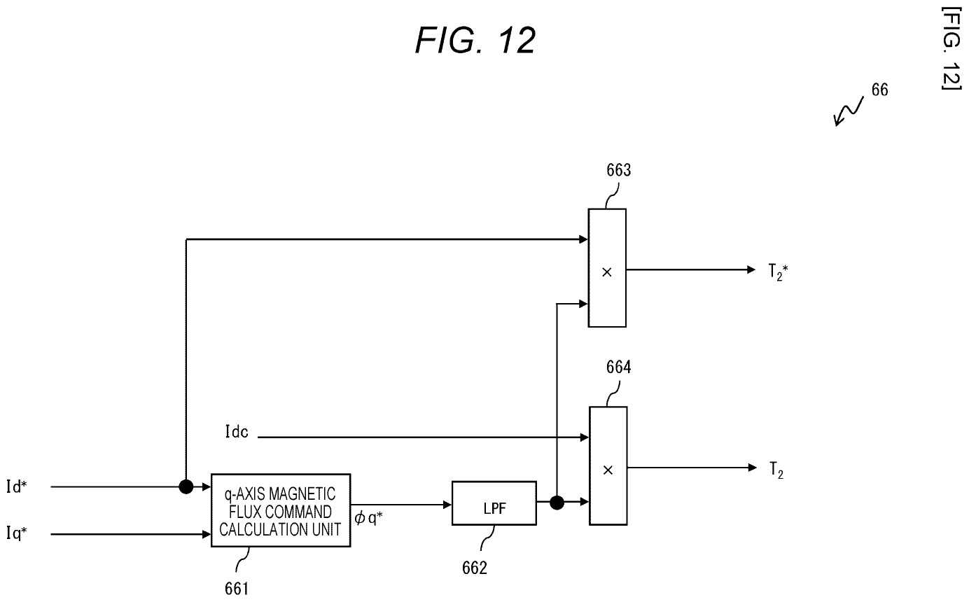

FIG. 12 is a block configuration diagram of the second torque command value calculation unit 66 according to the second embodiment.

The second torque command value calculation unit 66 includes a q-axis magnetic flux command calculation unit 661, a low-pass filter 662, and multipliers 663 and 664. Then, the second torque T2 and the second torque command value T2* used in the high torque region are calculated.

The q-axis magnetic flux command calculation unit 661 calculates, based on the d-axis current command value Id* and the q-axis current command value Iq*, the q-axis magnetic flux command value φq* in, for example, a lookup table. The calculated q-axis magnetic flux command value φq* is input to the multipliers 663 and 664 through the low-pass filter 662. The multiplier 663 multiplies the q-axis magnetic flux command value φq* passing through the low-pass filter 662 by the d-axis current command value Id* to output the result as the second torque command value T2*. The multiplier 664 multiplies the q-axis magnetic flux command value φq* passing through the low-pass filter 662 by the d-axis current detection value Idc, and outputs the result as the second torque T2. As described above, although the q-axis magnetic flux command value φq* is multiplied so as to be the dimension of the torque, basically, control is performed such that the d-axis current detection value Idc and the d-axis current command value Id* match. This is to reduce a torque margin in the high torque region.

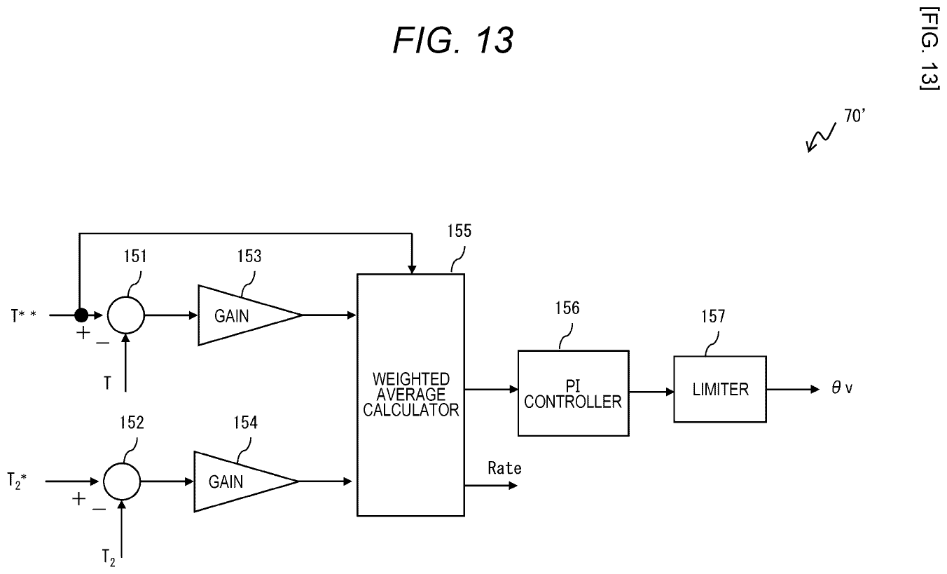

FIG. 13 is a block configuration diagram of the voltage phase control unit 70′ according to the second embodiment.

As illustrated in FIG. 13, the voltage phase control unit 70′ calculates the difference between the torque T and the torque command value T** by the differentiator 151, multiplies the difference by a first gain 153, and inputs the result to one of weighted average calculators 155. In addition, a difference between the second torque T2 and the second torque command value T2* is calculated by a differentiator 152, multiplied by the second gain 154, and input to another of the weighted average calculators 155. The torque command value T** is input to the weighted average calculator 155 as a reference, and the weighted average calculator 155 outputs the difference between the torque T and the torque command value T** when the torque command value T** is less than a predetermined value.

The weighted average calculator 155 outputs the difference between second torque T2 and second torque command value T2* when torque command value T** is equal to or greater than the predetermined value. That is, the difference between the second torque T2 and the second torque command value T2* is used in the high torque region (hereinafter, referred to as using a second torque), and the difference between the torque T and the torque command value T** is used in the low torque region (hereinafter, referred to as using the first torque). The ratio of these weighted averages is output as the Rate information to the current command value generation unit 50′.

The output of the weighted average calculator 155 is input to a PI controller 156 (or the I controller) and passes through the PI controller 156 (or the I controller), and a limiter 157 performs limiting processing in a range in which the torque does not exceed a peak, and outputs the voltage phase angle θv. Note that the torque T may be input to the weighted average calculator 155 as a reference instead of the torque command value T**, the difference between the second torque T2 and the second torque command value T2* may be output when the torque T is less than a predetermined value, and the difference between the torque T and the torque command value T** may be output when the torque T is equal to or greater than the predetermined value.

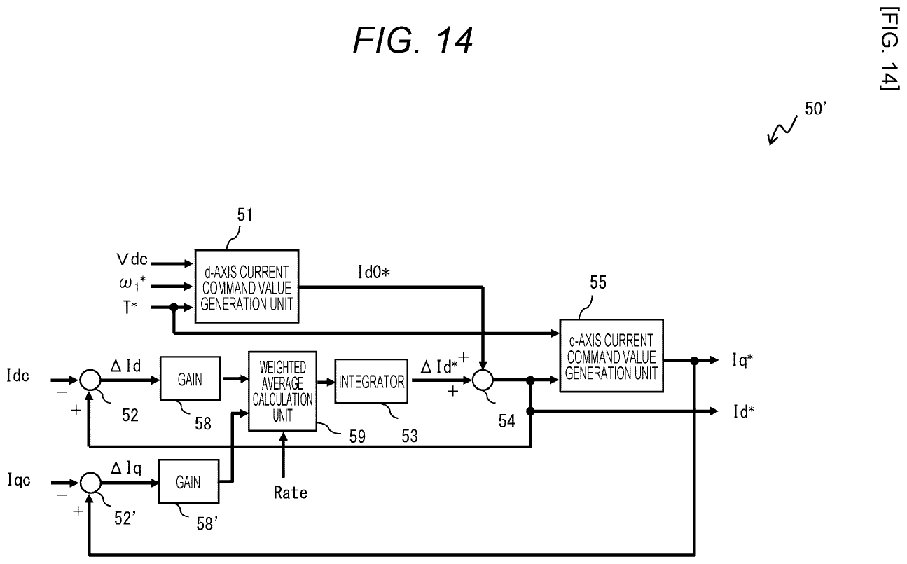

FIG. 14 is a block configuration diagram of the current command value generation unit 50′ according to the second embodiment.

In current command value generation unit 50 illustrated in FIG. 6, the d-axis current command value Id* is obtained such that the d-axis current command value Id* matches with the d-axis current detection value. However, in the current command value generation unit 50′ illustrated in FIG. 14, a weighted average of the d-axis current detection value and the q-axis current detection value is taken according to the Rate information, and the d-axis current command value Id* is obtained such that the d-axis current command value Id* matches with the weighted average. The same portions as those of the current command value generation unit 50 in FIG. 6 are denoted by the same reference numerals, and the description thereof will be simplified.

The subtractor 52 calculates the current difference ΔId between the previous value of the d-axis current command value Id* and the d-axis current detection value Idc, and outputs the current difference ΔId to a weighted average calculation unit 59 via a gain 58. The gain 58 is the cutoff frequency ωfb.

The subtractor 52′ calculates the current difference ΔIq between the previous value of the q-axis current command value Iq* and the q-axis current detection value Iqc, and outputs the current difference ΔIq to the weighted average calculation unit 59 via a gain 58′. The gain 58′ is Kfb shown in Expression (8) such that the response does not change.

The weighted average calculation unit 59 and the integrator 53 output the d-axis current command value correction amount ΔId* based on the current differences ΔId and ΔIq by following Expression (13).

$$Δ {Id}^{⋆} = \int ( Rate \times Kfb \times Δ Iq + ( 1 - Rate ) \times ω fb \times Δ Id ) \qquad ( 13 )$$

The Rate information is 0 in the low torque region and 1 in the high torque region, and takes a value between 0 to 1 depending on the torque therebetween.

As described above, the current command value generation unit 50′ uses the d-axis current difference ΔId for correction of the d-axis current command value Id* when performing the voltage phase control using the first torque, and uses the q-axis current difference ΔIq for correction of the d-axis current command value Id* when performing the voltage phase control using the second torque. Since the second torque is actually controlled such that the d-axis current detection value Idc matches with the d-axis current command value Id*, the current difference ΔId is basically 0 and cannot be used for current correction. Therefore, the current difference ΔIq of the q-axis current is preferably used for correction of the d-axis current command value Id*. On the other hand, as described above, in a case where the current difference ΔIq is used, the effect is small in a region where the torque is low. Therefore, in the low torque region using the first torque, it is preferable to use the current difference ΔId for correction of the d-axis current command value Id*.

According to the present embodiment, even in the voltage phase control using both the first torque and the second torque, the current command value can be matched with the current detection value. Therefore, effects similar to those described in the first embodiment are obtained.

### Fourth Modification

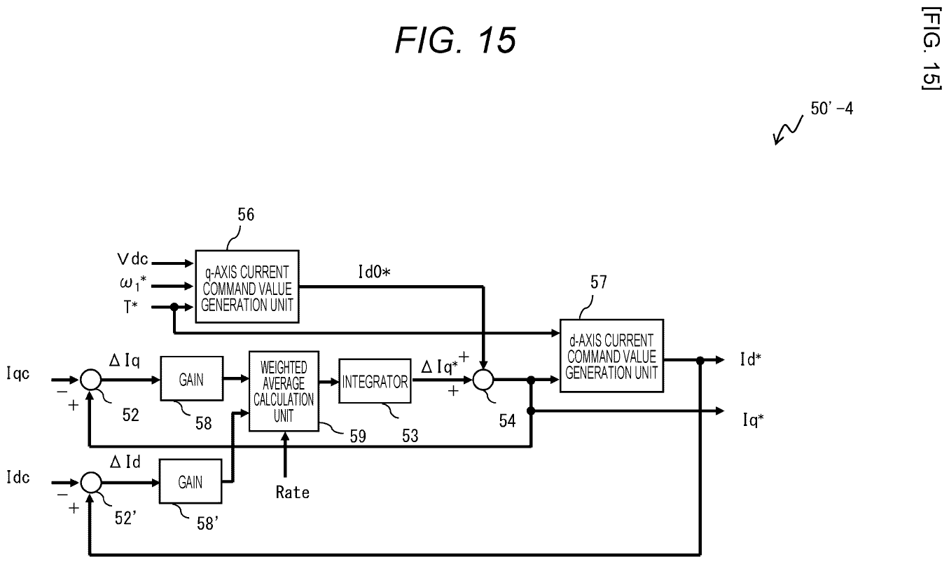

FIG. 15 is a block configuration diagram of a current command value generation unit 50′-4 according to a fourth modification of the second embodiment.

The current command value generation unit 50′ illustrated in FIG. 14 takes the weighted average of the d-axis current detection value and the q-axis current detection value according to the Rate information, and obtains the d-axis current command value Id* such that the d-axis current command value Id* matches with the weighted average. On the other hand, the current command value generation unit 50-4 illustrated in FIG. 15 takes the weighted average of the d-axis current detection value and the q-axis current detection value according to the Rate information, and obtains the q-axis current command value Iq* such that the q-axis current command value Iq* matches with the weighted average. The same portions as those of the current command value generation unit 50′ in FIG. 14 are denoted by the same reference numerals, and the description thereof will be simplified.

The q-axis current command value generation unit 56 generates, from the motor torque command value T*, the DC voltage Vdc, and the rotation speed ω1*, an initial q-axis current command value Iq0* in a lookup table, for example.

The subtractor 52 calculates the current difference ΔIq between the previous value of the q-axis current command value Iq* and the q-axis current detection value Iqc, and outputs the current difference ΔIq to the weighted average calculation unit 59 via the gain 58. The gain 58 is the cutoff frequency ωfb.

The subtractor 52′ calculates the current difference ΔId between the previous value of the d-axis current command value Id* and the d-axis current detection value Idc, and outputs the current difference ΔId to the weighted average calculation unit 59 via the gain 58′. The gain 58 is Kfb2 shown in Expression (12) such that the response does not change.

The weighted average calculation unit 59 and the integrator 53 output the q-axis current command value correction amount ΔIq* based on the current differences ΔId and ΔIq by following Expression (14).

$$Δ {Iq}^{⋆} = \int ( Rate \times ω fb \times Δ Iq + ( 1 - Rate ) \times Kfb 2 \times Δ Id ) \qquad ( 14 )$$

The Rate information is 0 in the low torque region and 1 in the high torque region, and takes a value between 0 to 1 depending on the torque therebetween.

The adder 54 adds the q-axis current command value correction amount ΔIq* to the initial q-axis current command value Iq0* and outputs the q-axis current command value Iq*.

The d-axis current command value generation unit 57 generates, based on the calculated q-axis current command value Iq* and motor torque command value T*, the d-axis current command value Id* using a lookup table or the like. The d-axis current command value Id* is the q-axis current command value Iq* along an equal torque line in relationship to the calculated q-axis current command value Iq*.

As described above, the current command value generation unit 50-4 uses the d-axis current difference ΔId for correction of the q-axis current command value Iq* when performing the voltage phase control using the first torque, and uses the q-axis current difference ΔIq for correction of the q-axis current command value Iq* when performing the voltage phase control using the second torque.

In the current command value generation unit 50′ of the second embodiment illustrated in FIG. 14, the d-axis current command value Id* is obtained first. However, even when the q-axis current command value Iq* is obtained first as in the fourth modification, a similar effect can be obtained.

The current command value generation unit 50′ of the second embodiment and the current command value generation unit 50-4 of the fourth modification generate the d-axis current command value Id* and the q-axis current command value Iq* such that the d-axis current command value Id* approaches the d-axis current detection value Idc in a case where the torque of the motor 200 is in the low torque region, and such that the q-axis current command value Iq* approaches the q-axis current detection value Iqc in a case where the torque of the motor 200 is in the high torque region.

### Third Embodiment

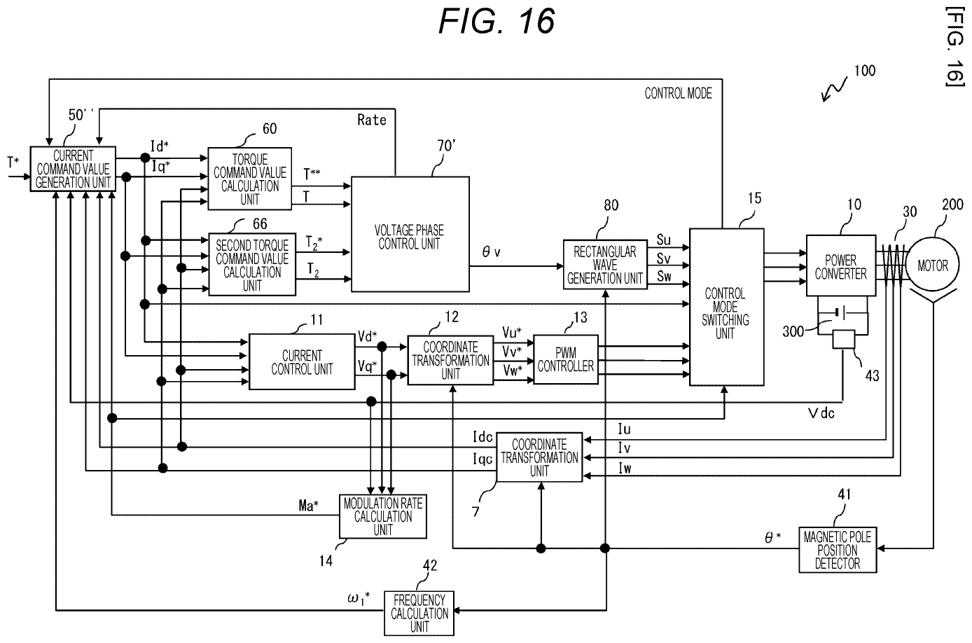

FIG. 16 is an overall configuration diagram of the motor control device 100 according to a third embodiment of the present invention.

As compared with the second embodiment illustrated in FIG. 11, the third embodiment includes a current control unit 11, a coordinate transformation unit 12, a PWM controller 13, a modulation rate calculation unit 14, and a control mode switching unit 15 in order to perform two-axis vector control. In addition, the third embodiment will be described as an example in which the magnetic flux command calculation unit 45, the magnetic flux estimation unit 46, and the damping ratio control unit 90 described in the first embodiment are not provided, but these configurations may be provided. The same portions as those of the motor control device 100 of the second embodiment illustrated in FIG. 11 are denoted by the same reference numerals, and the description thereof will be simplified.

The current control unit 11 performs PI control such that the d-axis current command value Id* matches with the d-axis current detection value Idc, and further the q-axis current command value Iq* matches with the q-axis current detection value Iqc, and outputs a d-axis voltage command value Vd* and a q-axis voltage command value Vq* to the coordinate transformation unit 12 and the modulation rate calculation unit 14.

The coordinate transformation unit 12 coordinate-transforms the d-axis voltage command value Vd* and the q-axis voltage command value Vq* into three-phase voltage command values Vu*, Vv*, and Vw* based on the rotation angle information θ*, and outputs the three-phase voltage command values Vu*, Vv*, and Vw* to the PWM controller 13.

For example, the PWM controller 13 compares the three-phase voltage command values Vu*, Vv*, and Vw* with a triangular wave, generates pulse signals corresponding to the three-phase voltage command values Vux, Vv*, and Vwx, and outputs the pulse signals to the control mode switching unit 15.

In a case where a sine wave modulation scheme (a modulation scheme in which a ratio of an output voltage amplitude to the DC voltage Vdc is 0.866 (≈√3/2) at the maximum in a line-to-line voltage) is applied, the modulation rate calculation unit 14 calculates a modulation rate Ma* by following Expression (15) and outputs the modulation rate Ma* to the control mode switching unit 15 and the current command value generation unit 50″.

$$\begin{matrix}[ Mathematical Formula 7 ] & \\ {M}_{a}^{*} = \frac{2 \sqrt{{V}_{d}^{* 2} + {V}_{q}^{* 2}}}{{V}_{dc}} & ( Expression 15 )\end{matrix}$$

To the control mode switching unit 15, the pulse signals Su, Sv, and Sw corresponding to the voltage phase angle θv are input from the rectangular wave generation unit 80, and the pulse signals corresponding to the three-phase voltage command values Vu*, Vv*, and Vw* are input from the PWM controller 13. Furthermore, the modulation rate Ma* and the d-axis current command value Id* are input, and the drive control of the power converter 10 is performed by switching between the two-axis vector control and the voltage phase control. Specifically, when the modulation rate Ma* becomes a predetermined value or more, the control mode is switched from the two-axis vector control to the voltage phase control. In addition, when the amplitude of the d-axis current command value Id* becomes equal to or less than a predetermined value, the control mode is switched from the voltage phase control to the two-axis vector control. Then, the control mode indicating the mode state is output to the current command value generation unit 50″.

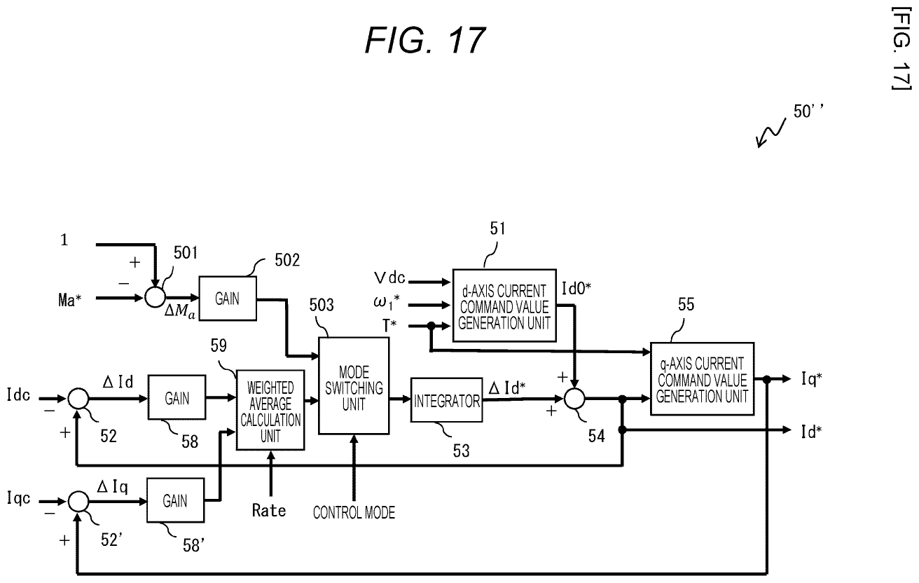

FIG. 17 is a block configuration diagram of the current command value generation unit 50″ according to the third embodiment.

In the block configuration diagram of the current command value generation unit 50′ in the second embodiment illustrated in FIG. 14, a subtractor 501, a gain 502, and a mode switching unit 503 are provided. The same portions as those of the current command value generation unit 50′ in FIG. 14 are denoted by the same reference numerals, and the description thereof will be simplified.

The subtractor 501 subtracts the modulation rate Ma* from 1, obtains a difference ΔMa, and outputs the difference ΔMa to the gain 502. For example, the gain 502 multiplies the difference ΔMa by a cutoff frequency ωfw, divides the result by the d-axis inductance Ld and the rotation speed ω1*, multiplies the result by the DC voltage Vdc/2, and outputs the result to the mode switching unit 503.

The mode switching unit 503 selects the output of the gain 502 and the output of the weighted average calculation unit 59 according to the control mode. In the voltage phase control, the output of the weighted average calculation unit 59 is selected, and in the two-axis vector control, the output of the gain 502 is selected.

The current command value generation unit 50″ performs an operation similar to that of the second embodiment in the voltage phase control, and performs flux weakening control such that the modulation rate Ma* becomes 1 or less when switching to the two-axis vector control. Here, the integrator 53 is shared by the two-axis vector control and the voltage phase control, so that the previous integrated value can be held at the time of switching, whereby switching can be performed seamlessly.

Although the flux weakening control is performed using the modulation rate in the present embodiment, the flux weakening control may be performed using the output voltage. In addition, although the mode switching is performed using the modulation rate Ma* or the d-axis current command value Id* in the present embodiment, the mode switching may be performed using other parameters. Furthermore, the motor 200 is driven by appropriately switching, for example, between the voltage phase control in a high rotation speed region of the motor 200 and the two-axis vector control in other rotation speed regions according to an operating condition (typically, rotation speed, rotation frequency, torque, or combinations thereof) of the motor 200.

According to the present embodiment, in a case where the current command value is used for switching between the voltage phase control and the two-axis vector control, the current command value matches with the current detection value, so that switching can be performed more accurately, and torque fluctuation at the time of switching can be suppressed. In an example to which the present embodiment is not applied, the current command value does not match with the current detection value, so that the torque fluctuation cannot be completely eliminated when the voltage phase control is switched to the two-axis vector control.

### Fourth Embodiment

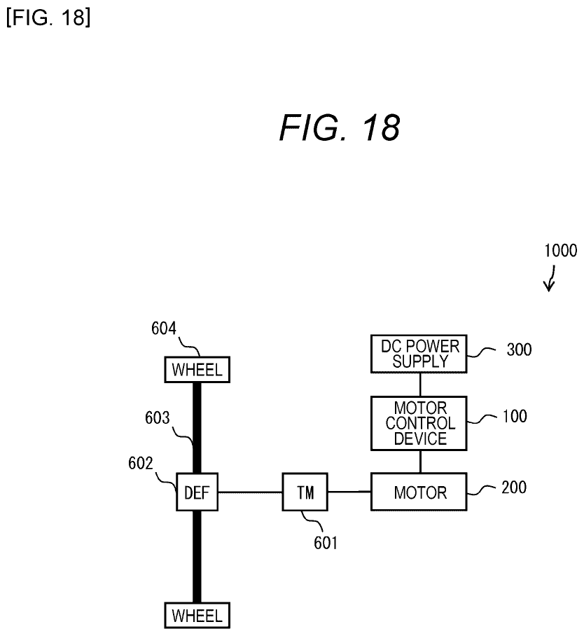

FIG. 18 is a configuration diagram of an electric vehicle 1000 according to a fourth embodiment of the present invention.

The electric vehicle 1000 includes the motor 200 controlled by the motor control device 100 described in the first to third embodiments, and the motor 200 is used as a drive source.

The motor control device 100 converts DC power from the DC power supply 300 into AC power to drive the motor 3. The motor 200 is connected to a transmission 601. The transmission 601 is connected to a drive shaft 603 via a differential gear 602 and supplies power to wheels 604. Note that a configuration in which direct connection is made to the differential gear 602 without providing the transmission 601 or a configuration in which the motor 200 and the motor control device 100 are applied to each of front wheels and rear wheels may be adopted.

In an automobile, the torque fluctuation of the motor 200 directly affects ride comfort. Specifically, in cases where, for example, is a there large difference between the deceleration caused by events such as re-adhesion after idling or sudden braking and the subsequent acceleration, the torque fluctuation of the motor 200 occurs and the ride comfort deteriorates. In a case where the first embodiment to the second embodiment are applied to automobiles, even in a case where the voltage phase control is performed in the high rotation speed region of the motor 200, the current command value and the current detection value of the motor do not diverge from each other, and the operation of the control using the current command value is stabilized, so that the torque fluctuation can be suppressed. In addition, in a case where the third embodiment is applied to automobiles, even in a case where the motor 200 frequently transitions from the low rotation speed region to the high rotation speed region and switches between voltage phase control and two-axis vector control, the torque fluctuation at the time of switching can be suppressed. As described above, the automobiles are an application in which the demand for torque fluctuation is more severe than other applications, and the effects described in the first to third embodiments remarkably appear. In railways, the torque fluctuation directly affects ride comfort similarly to the automobiles. By applying the present invention, the torque fluctuation can be suppressed in the automobiles and the railways, and ride comfort can be improved.

In the first to third embodiments, the motor control device 100 has been described to have a configuration of a plurality of blocks, but a desired block excluding the power converter 10 may be configured by a computer including a CPU, a memory, or the like. In this case, the computer performs the above-described processing by executing a program stored in a memory or the like. In addition, all or part of the processing of the plurality of blocks may be realized by a hard logic circuit. Furthermore, the program may be stored in a storage medium in advance and provided. Alternatively, may be provided by a network line. Various forms of computer-readable computer program products, such as data signals, may be provided.

According to above-described embodiments, the following operational effects can be obtained.

(1) The motor control device 100 includes: the current command value generation units 50, 50′, and 50″ which generate current command values based on the motor torque command value T* and the rotation speed ω1* of the motor 200; the torque command value calculation unit 60 which calculates the torque command value T* based on the generated current command values Id* and Iq* and calculates the torque T of the motor 200 based on the current detection values Idc and Iqc flowing through the motor 200; the voltage phase control units 70 and 70′ which control the voltage phase angle θv such that the torque T of the motor 200 matches with the torque command value T*; and a power conversion unit (rectangular wave generation unit 80, power converter 10) which converts DC power into AC power based on the voltage phase angle θv and the rotation angle information θ* of the motor 200 and outputs the converted AC power to the motor 200. The current command value generation units 50, 50′, and 50″ calculate the d-axis current command value Id* or the q-axis current command value Iq* such that a current command value of any one axis of the d-axis current command value Id* and the q-axis current command value Iq* constituting the current command value approaches the current detection values Idc and Iqc of the axis. As a result, the divergence between the current command values Id* and Iq* and the current detection values Idc and Iqc of the motor 200 can be suppressed, and the operation of the control using the current command values Id* and Iq* can be stabilized.

The present invention is not limited to the above-described embodiment, and other forms conceivable within the scope of the technical idea of the present invention are also included within the scope of the present invention as long as the features of the present invention are not impaired. In addition, the above-described embodiment and a plurality of modifications may be combined.

### REFERENCE SIGNS LIST

10 power converter
11 current control unit
12 coordinate transformation unit
13 PWM controller
14 modulation rate calculation unit
15 control mode switching unit
41 magnetic pole position detector
42 frequency calculation unit
43 voltage detector
44 coordinate transformation unit
50, 50′, 50″, 50-1, 50-2, 50-3, 50′-4 current command value generation unit
51, 57 d-axis current command value generation unit
55, 56 q-axis current command value generation unit
52, 52′ subtractor
53 integrator
54 adder
59 weighted average calculation unit
60 torque command value calculation unit
66 second torque command value calculation unit
70, 70′ voltage phase control unit
80 rectangular wave generation unit
61, 61′ dq-axis flux calculation unit
62, 62′, 63, 63′ multiplier
64, 64′ subtractor
65, 65′ amplifier
71 differentiator
72 PI controller
73 limiter
90 damping ratio control unit
91, 91′ first-order lag calculator
92, 92′ adder-subtractor
93, 93′ high-pass filter
94, 94′ multiplier
96 square sum calculator
97 divider
98 proportional element
81, 82, 83 adder
84, 84′, 84″ remainder calculation unit
85, 85′, 85″ differentiator
86, 86′, 86″ sign determination unit
100 motor control device
151, 152 differentiator
153 first gain
154 second gain
155 weighted average calculator
156 PI controller
200 motor
300 DC power supply
501 subtractor
502 gain
503 mode switching unit
601 transmission
602 differential gear
603 drive shaft
604 wheel
661 q-axis magnetic flux command calculation unit
662 low-pass filter
663, 664 multiplier
I torque
T* motor torque command value
T** torque command value
Idc d-axis current detection value
Iqc q-axis current detection value
Id* d-axis current command value
Iq* q-axis current command value
φd* d-axis magnetic flux command value
φq* q-axis magnetic flux command value
θv voltage phase angle
θe* rotation angle information
ω1* rotation speed
Vdc DC voltage

1. A motor control device comprising:
a current command value generation unit which generates a current command value based on a motor torque command value and a rotation speed of a motor;
a torque command value calculation unit which calculates a torque command value based on the generated current command value and calculates a torque of the motor based on a detection value of a current flowing through the motor;
a voltage phase control unit which controls a voltage phase angle such that the torque of the motor matches with the torque command value; and
a power conversion unit which converts DC power into AC power based on the voltage phase angle and rotation angle information of the motor, and outputs the converted AC power to the motor, wherein
the current command value generation unit calculates a d-axis current command value or a q-axis current command value such that a current command value of any one axis of the d-axis current command value and the q-axis current command value constituting the current command value approaches a current detection value of the axis.

2. The motor control device according to claim 1, wherein
the current command value generation unit calculates the d-axis current command value such that the d-axis current command value approaches a d-axis current detection value, and calculates the q-axis current command value along an equal torque line based on the calculated d-axis current command value.

3. The motor control device according to claim 1, wherein
the current command value generation unit calculates the q-axis current command value such that the q-axis current command value approaches a q-axis current detection value, and calculates the d-axis current command value along an equal torque line based on the calculated q-axis current command value.

4. The motor control device according to claim 1, wherein
the power conversion unit includes a rectangular wave generation unit which generates a rectangular wave pulse based on the voltage phase angle and the rotation angle information, and a power converter which changes DC power to AC power based on the rectangular wave pulse, and the motor is driven by the AC power.

5. The motor control device according to claim 1, wherein
a cutoff frequency of the voltage phase control unit is 3 times or more higher than a cutoff frequency of the current command value generation unit.

6. The motor control device according to claim 1, further comprising:
a damping ratio control unit which converts the d-axis current command value into a d-axis magnetic flux command value and the q-axis current command value into a q-axis magnetic flux command value, and calculates a phase angle correction amount for damping a vibration component of a magnetic flux value, wherein
the voltage phase angle is corrected based on the phase angle correction amount.

7. The motor control device according to claim 1, wherein
the current command value generation unit generates the d-axis current command value and the q-axis current command value such that the d-axis current command value approaches the d-axis current detection value in a case where the torque of the motor is in a low torque region, and such that the q-axis current command value approaches the q-axis current detection value in a case where the torque of the motor is in a high torque region,
the torque command value calculation unit calculates a second torque command value used in the high torque region, based on the generated d-axis current command value, and
the voltage phase control unit controls the voltage phase angle in the low torque region such that the torque of the motor matches with the torque command value, and controls the voltage phase angle in the high torque region such that the torque of the motor matches the second torque command value.

8. The motor control device according to claim 1, wherein
control is performed by switching between a two-axis vector control, which is provided with a current control unit which performs control such that the d-axis current command value and the d-axis current detection value match and further the q-axis current command value and the q-axis current detection value match, and a voltage phase control by the voltage phase control unit, according to an operating condition of the motor.

9. An electric vehicle comprising:
the motor control device according to claim 1; and
a motor which is controlled by the motor control device, wherein
the motor is used as a drive source.
